(19) United States
(12) Patent Application Publication
(10) Pub. No.: US 2017/0228240 A1
(43) Pub. Date: Aug. 10, 2017

(54) DYNAMIC REACTIVE CONTEXTUAL POLICIES FOR PERSONAL DIGITAL ASSISTANTS

(71) Applicant: Microsoft Technology Licensing, LLC, Redmond, WA (US)

(72) Inventors: Omar Zia Khan, Bellevue, WA (US); Ruhi Sarikaya, Redmond, WA (US)

(73) Assignee: Microsoft Technology Licensing, LLC, Redmond, WA (US)

(21) Appl. No.: 15/017,350

(22) Filed: Feb. 5, 2016

(51) Int. Cl. G06F 9/44; G06F 3/16; H04L 29/06

(52) U.S. Cl. CPC G06F 9/4446; H04L 67/42; G06F 3/167

(57) ABSTRACT

The present disclosure describes a system for responding to a user input and for providing a contextually-related communication related to the user input. The system receives an input from the user, determines contextual information about the input and generates a response to the input. The system also generates a contextually-related communication, where the contextually-related communication are based on the contextual information and can be based on user-specific information. The response to the input and the contextually-related communication are provided to the user. The system can also identify domains related to the input and use those domains in preparation of the contextually-related communication. The system can also present new system capabilities to the user after providing the response to the input.

### BACKGROUND

Computing device users interact with their computing devices to obtain information, schedule meetings and organize files. It is with respect to these and other general considerations that aspects have been made. Also, although relatively specific problems have been discussed, it should be understood that the aspects should not be limited to solving the specific problems identified in the background.

### SUMMARY

Aspect of the present disclosure relate to systems and methods that provides dynamic reactive services to a user through a computing device, such as a mobile device, tablet computer, or any other computing system. In an example, a device receives an input from a user. The device communicates the user's input to a server via a network. The server includes a response engine that also includes a data store. The data store includes knowledge data, personal data, contextual data, search data, social media data, services data, historical task sequence data and/or other types of relevant data. Upon receiving the input, the server analyzes the input. Analyzing the input may include using speech recognition to convert the speech to text. Then the text may be analyzed to determine the context of the input and/or semantically analyzed to determine an intent. Next, the server may identify domains that are related to the identified context. Based on the analyzed input, a response and contextually-related communication may be determined. The response and contextually-related communication may be determined by analyzing the data store, by analyzing historical task sequence data, and by analyzing a user interest model. Then the response and contextually-related communication are sent to the device. In certain instances, the response also includes a message for the user that the system can perform one or more various tasks that are related to the user's initial input. If a user response is needed, then the server sends a prompt for user input or response. If the server receives a reply from the user, then the process repeats. The process may continue to progress along a decision tree until the tree ends, until the user indicates they are done with the interaction, or until a given period of time elapses without user communication.

In exemplary aspects, a device receives a request for communication from a user. Then a personal digital assistant prompts the user for input. The device receives the input and sends the received input to the server for analysis. Next, the device receives a response to the input and contextually-related communication from the server. The response and contextually-related communication may be displayed to the user, and, in instances, the option for additional tasks are also presented to the user. If additional user input is needed, the personal digital assistant again prompts the user for input. If no additional user input is needed, then the device returns to the state where it waits for the user to initiate communication.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive aspects are described with reference to the following Figures.

FIG. 1 is an aspect of an example environment for providing dynamic reactive services.

FIG. 2 is a schematic diagram showing an aspect of an example data store used within the example environment shown in FIG. 1.

FIG. 3 is a block flow diagram of an aspect of an example method for providing dynamic contextual responses.

FIG. 4 is a schematic diagram showing an aspect of the analyze input operation of the example method in FIG. 3.

FIG. 5 is a schematic diagram showing an aspect of the determine response and contextually-related communication operation of the example method in FIG. 3.

FIG. 6 is a block flow diagram of an aspect of an example method for receiving and presenting dynamic contextual responses.

FIG. 7 is a block diagram illustrating example physical components of a computing device with which aspects of the disclosure may be practiced.

FIGS. 8A and 8B are simplified block diagrams of a mobile computing device with which aspects of the present disclosure may be practiced.

FIG. 9 is a simplified block diagram of a distributed computing system in which aspects of the present disclosure may be practiced.

FIG. 10 illustrates a tablet computing device for executing one or more aspects of the present disclosure.

### DETAILED DESCRIPTION

Various aspects are described more fully below with reference to the accompanying drawings, which form a part hereof, and which show specific exemplary aspects. However, aspects may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems and/or devices. Accordingly, aspects may take the form of a hardware implementation, an entirely software implementation or an implementation combining software and hardware aspects. The following detailed description is, therefore, not to be taken in a limiting sense.

Aspects of the present disclosure relate to a system and method for presenting responses to user inputs, including contextually-related communication that is related or relevant to the user inputs. Some systems are capable of reactive policies, whereby a system can respond reactively to a user query. However, those systems are not capable of subsequent action based on the user's reply to the presented information. In other words, the communication between the user and the computing device ends after the user's input has been responded to once. Furthermore, those systems cannot present additional information that is tailored to a specific user's interests or context.

The disclosed examples provide for an enhanced user experience through multiple exchanges between the user and a personal digital assistant running on a computing device. The system may rely upon information relating to the user's interests, context, and/or decision sequences for a particular context, to anticipate the needs of the user during the interaction. Further, the system can carry over information (e.g., slots, entities, etc.) from a current request and combine those data with user-specific information available to the system to make an inference. Based on that inference, the system may present additional tasks or queries to the user. A task is an operation that may be performed by a device. Generally, a task may require an instruction and/or data in order to execute an operation.

Many personal digital assistant systems are cloud-based and have functionalities and capabilities updated without the user's knowledge. In the contemplated aspects, the system can, within the proper context, inform the user about these capabilities when the user is actually able to make use of the capabilities. As such, among other benefits, the systems and methods disclosed herein provided an enhanced user experience by offering functionality that a user may be unaware of.

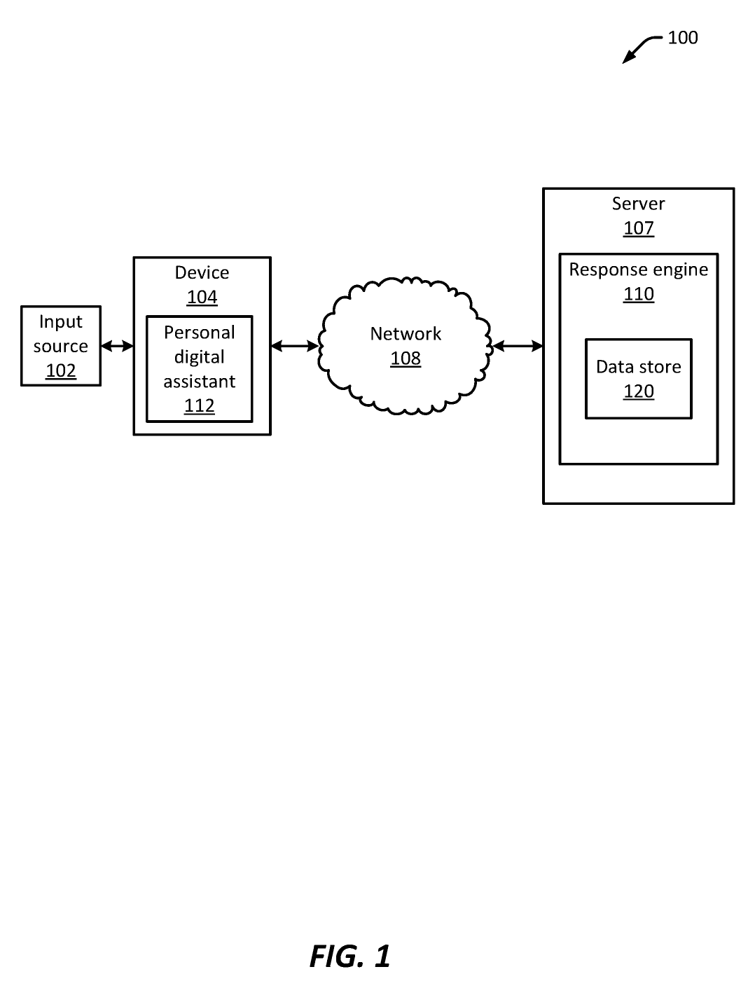

FIG. 1 is an aspect of an example system 100 capable of providing dynamic reactive services. The example system 100 includes an input source 102 and a device 104 with a personal digital assistant 112. For ease of illustration, the examples disclosed herein are with respect to a personal digital assistant. However, one of skill in the art will appreciate that other types of processes, such as a search engine, may employ the aspects disclosed herein without departing from the scope of this disclosure. Via network 108, the device 104 is in communication with a server 107 hosting a response engine 110. The response engine 110 includes a data store 120. Other aspects can include more or fewer components.

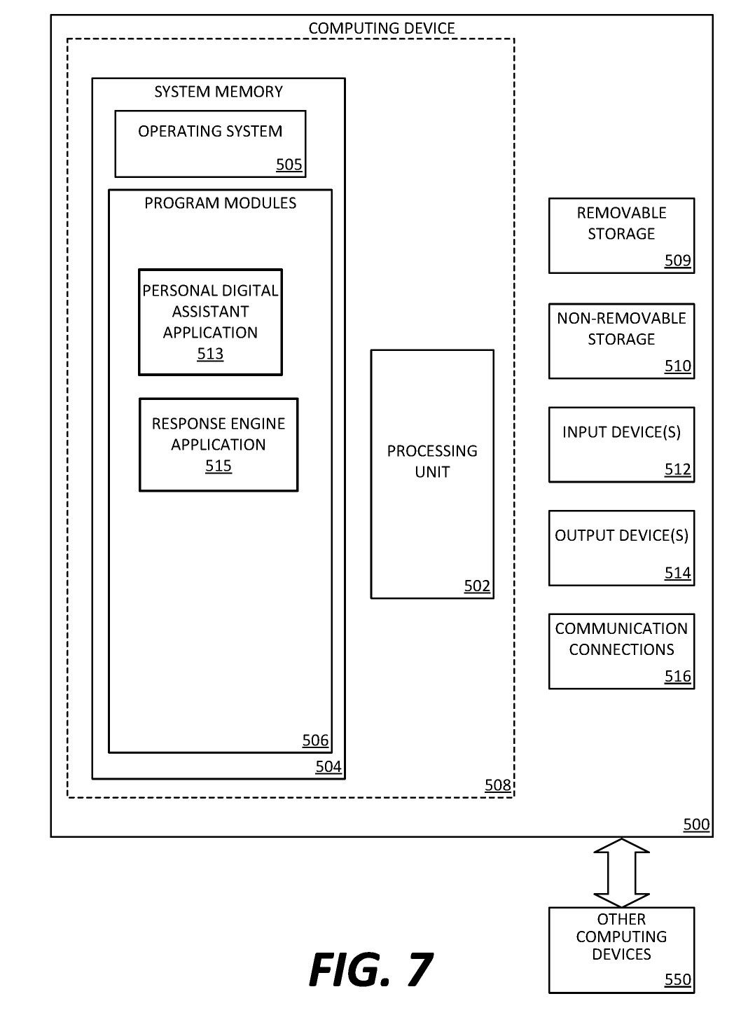

The personal digital assistant 112 receives input from an input source 102. The input source 102 may be a user or another source, such as an email application or dinner reservation application. In embodiments where a user interacts with the personal digital assistant 112, the device 104 receives input via a microphone, keyboard, and/or display supported by the device 104. The device 104 may be a general computing device, a tablet computing device, a smartphone, or a mobile computing device. Example aspects of device 104 are shown and described with reference to FIGS. 7-10. Aspects of this disclosure may also be performed using other types of devices such as personal computers, televisions, set-top-boxes, etc.

Generally, the personal digital assistant 112 communicates with the user 102. An example of a commercially available personal digital assistant 112 is Microsoft® Cortana®. Communication from the user can include instructions or requests. These instructions can be spoken or entered using a keypad. The personal digital assistant 112 sends the instructions or request to the response engine 110 via network 108 and receives responses and additional information back from the response engine 110.

As mentioned, device 104 communicates with the server 107 over network 108. Network 108 may be any type of wired or wireless network, for example, the Internet, an intranet, a wide area network (WAN), a local area network (LAN), and a virtual private network (VPN).

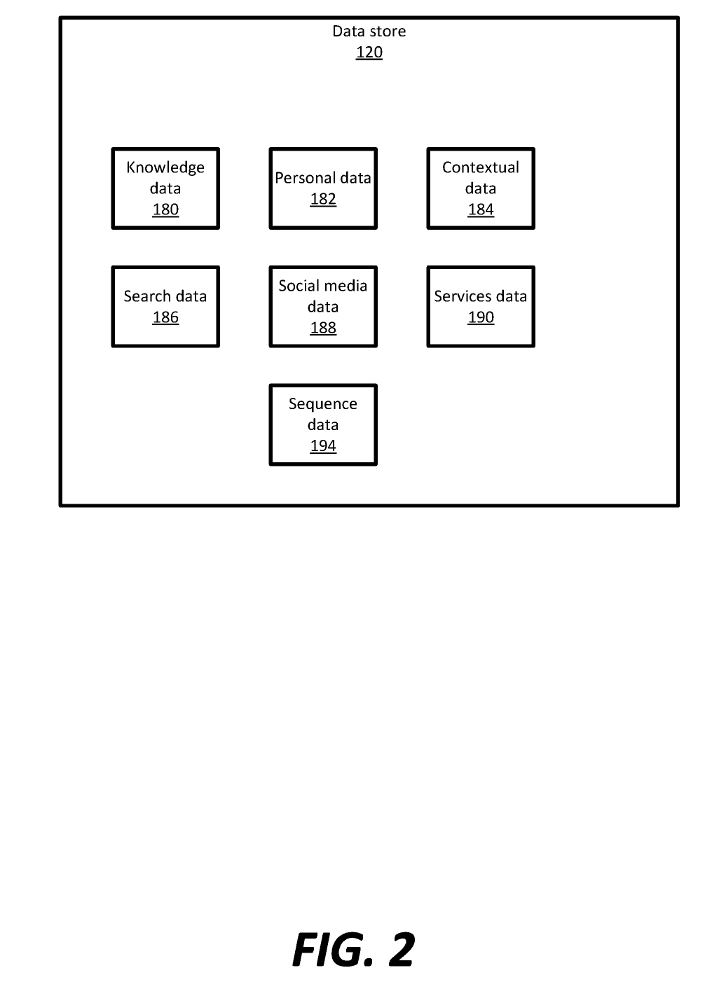

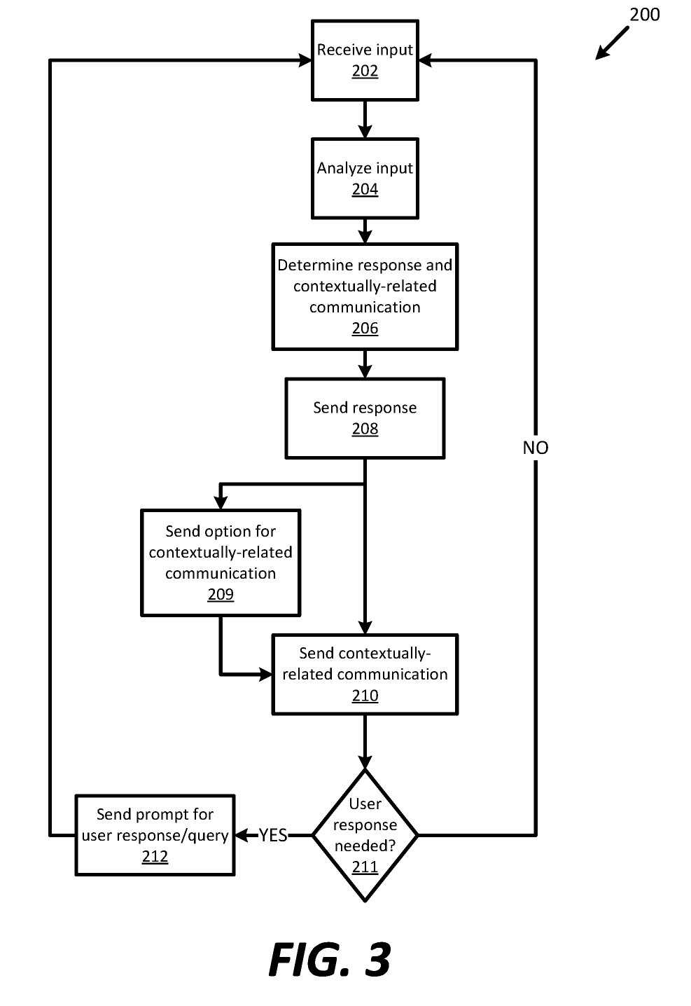

Response engine 110, hosted by server 107, analyzes the data received from device 104 and determines one or more responses or queries based on the data received from device 104. An exemplary data store 120 is shown and described in more detail with reference to FIG. 2, below. An exemplary method 200 for analyzing an input from a user 102 is shown and described in more detail with reference to FIG. 3, below. As used herein, “response” means a particular output given an input or, more broadly, a system or application policy to implement a specific behavior.

Response engine 110, including data store 120, may operate over distributed systems (e.g., cloud-based computing systems), where application functionality, memory, data storage and retrieval and various processing functions may be operated remotely from each other over a distributed computing network, such as the Internet or an intranet

Response engine 110 includes processes for automatic speech recognition, spoken language understanding, and/or natural language generation. Languages, such as English, Spanish, Mandarin, and others, are supported by these modules. Response engine 110 also includes a dialog manager that, generally, receives and interprets inputs and determines the proper subsequent actions.

Device 104 can send contextually-related communication in addition to the user's input to the response engine 110. For example, device 104 sends global positioning system (GPS) data, time and date data to the response engine 110, where those data are associated with the received input.

FIG. 2 is a block diagram illustrating exemplary data stored in the data store 120. The example data store 120 includes knowledge data 180, personal data 182, contextual data 184, search data 186, social media data 188, services data 190, and historical task sequence data 194. Other aspects can include more or fewer components.

Data in data store 120 that is associated with user 102 can be accumulated over time as the user 102 accesses and uses services provided by device 104. Generally, the response engine 110 accesses data store 120 when generating a system response to the user's input, where the user's input includes a query or a request/instruction. Data in data store 120 can also be imported from other data sources, such as email data even if email is not directly used on the current device 104.

Some inputs received by the systems and methods disclosed herein may include queries, such as “what is the weather today?” or “what is the address of the nearest bank?” In examples, the queries may or may not be provided in a natural language format. Knowledge data 180 may include data responsive to these types of queries where the responses are static across different users. For example, addresses of restaurants, definitions of words, lists of actors in a movie, etc., are all the same regardless of who requests the information. Knowledge data 180 can also include location-specific data, such as the weather, traffic, or currency conversion rates.

In many instances, the exemplary data store 120 may store personal data 182 that is associated with a particular account, profile, and/or device 104. For example, personal data 182 includes a user's home address and work address. Personal data 182 may also include one or more contacts of the user 102, along with associated contact information and any familial relationships to the user 102.

Contextual data 184 include data related or specific to the received data input. For example, contextual data 184 includes position data such as GPS data and/or an internet protocol (IP) address. Contextual data 184 also includes date, day of the week, time and time zone information.

Search data 186 may include search history associated with a user, an account, a profile, a device, etc. In some instances, a user may have a common user profile across one or more computing devices, such as a mobile telephone, a tablet computer, and a desktop computer. Search data 186 includes data from the user's searches on any or all of those devices.

Social media data 188 include the user's data from one or more social media platforms that are associated with a user, an account, a profile, a device, etc. For example, a user's posts to a social media platform may be used to determine their interests, fields of work, likes, and dislikes. Example social media platforms include Facebook™, Twitter™, LinkedIn™, and Instagram™.

Services data 190 may include data from using services hosted or performed by the device 104. For example, a user's calendar including appointments and meetings, call history, and/or instant message history are examples of services data 190. Services data 190 may also include the various applications (“apps”) on the device 104, including information on whether the app is accessible by outside applications. For example, the personal digital assistant 112 might make a restaurant reservation using a restaurant reservation app or call a taxi cab, or similar service, using a vehicle service app. By including data about other types of applications, the examples disclosed herein may identify additional tasks that may be performed by the other applications in response to the received query.

Sequence data 194 may include decision trees, process flows, or modules for tasks. For example, sequence data 194 may include decision trees for booking a restaurant reservation, taking a trip, and/or asking for directions. As an example, booking a restaurant reservation can include, in some order, verifying the user is available based on their calendar, determining how the user will get to the restaurant, notifying other people in the reservation, and providing directions to the restaurant. As such, the decision trees may define the type of information needed and/or the operations required to complete a task.

Sequence data 194 may also include inputs that were previously received, especially with respect to a given interaction, also termed historical task sequence data. For example, if a user's input triggers a context with four queries, sequence data 194 stores each user response and tracks the progression through the context's decision tree.

FIG. 3 illustrates a block flow diagram of an exemplary method 200 for providing dynamic contextual responses. The example method 200 may include receiving an input (operation 202), analyzing the input (operation 204), determining a response and contextually-related communication (operation 206), sending the response (operation 208), sending an option for contextually-related communication that may be analyzed (operation 209), deciding whether a user response is needed (operation 211), and sending a prompt for a user response/query (operation 212). The exemplary method 200 shown in FIG. 3 may performed by the server 107, shown and described with reference to FIG. 1 above. Other aspects can include more or fewer operations.

The example method 200 begins when the server receives an input from a device (operation 202). Typically, the user initiates the communication by activating an application or pressing a button or otherwise activating an application, such as a personal digital assistant, on the device. In response to activation, input may be received by the user via a graphical user interface or via audible input. In other examples, the received input may be provided by another application or process, not directly from a user.

The input may be a query, such as “what is the nearest restaurant?”, a request to complete a task, such as “send an email” or “create a reminder”, and/or an instruction, such as “make a dinner reservation”, to name a few examples. Typically, user input is spoken and received by the device's microphone, although other input methods are possible, such as typing.

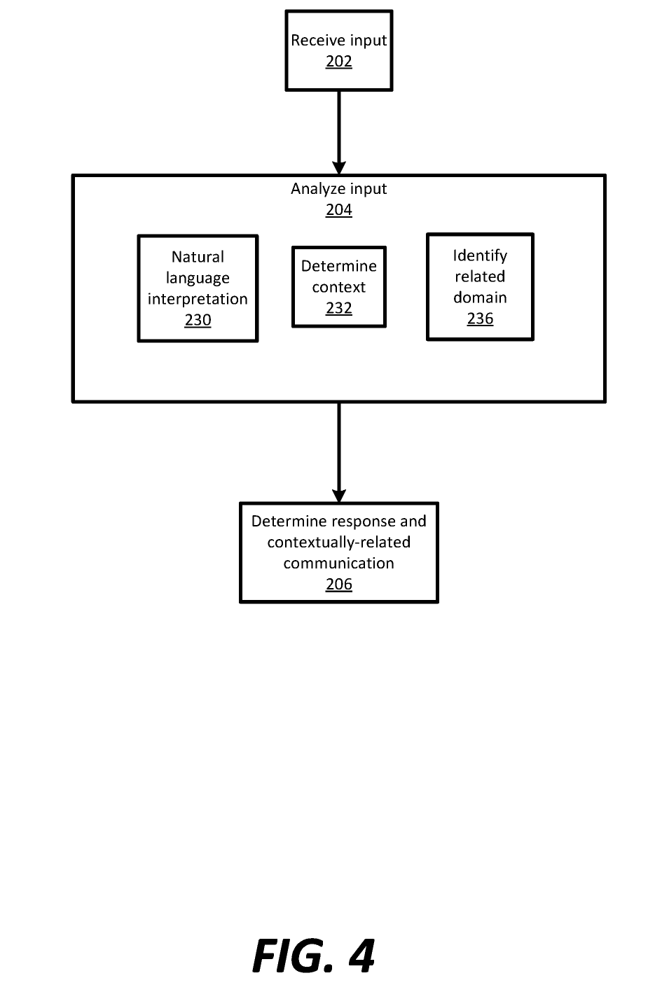

Upon receiving the input (operation 202), the input may be analyzed (operation 204). Referring now to FIG. 4, analyze input (operation 204) includes natural language interpretation (operation 230), determining context (operation 232), and identifying related domains (operation 236). Analyze input (operation 204) may include more or fewer operations in other aspects.

During operation 230, the system performs a natural language interpretation process. For example, the input may be a user's speech and/or an input typed into a device. The natural language interpretation process (operation 230) analyzes the input and renders the input into a form that is understood by an application. In aspects, operation 230 includes a speech recognition process that processes a user's spoken inputs. Once the speech is processed into a form understood by an application, the text is analyzed to determine the context (operation 232).

Operation 232 includes identifying what the input is requesting as well as identifying the context of the request. For example, the context is determined by identifying key words within the input. Then those key words are matched with words pre-associated with one or more contexts. Additionally, context may also include other aspects surrounding the input, such as the time of day, whether the user is travelling, the user's location, etc. Analyzing the text may also include semantically analyzing the text to determine the user's intent and/or the context of the input.

Identifying the relevant context provides guidance about relevant domains, where the domains include information used to identify the questions or sequences of questions and inputs that are most relevant to the user at the given time. Example contexts include an existing restaurant reservation, current traveling mode with intended destination, and calendar appointments.

After the context is determined (operation 232), related domains are identified (operation 236). Here, the keywords and context identified during operation 232 are compared to a table including domains and related domains. For example, if the text representing the user's input is in the restaurant context, related domains include location, calendar, contacts, weather, traffic, and transportation, to name a few.

After analyzing the user's input (operation 204), the response and any related additional prompts are determined (operation 206). Operation 206 may receive information related to the user's input, context for the input or input provider (i.e., user), intent related to the input, and domains related to the input identified during operation 204. In alternate embodiments, information about the context, intent, domains, etc., may be identified or generated at operation 206.

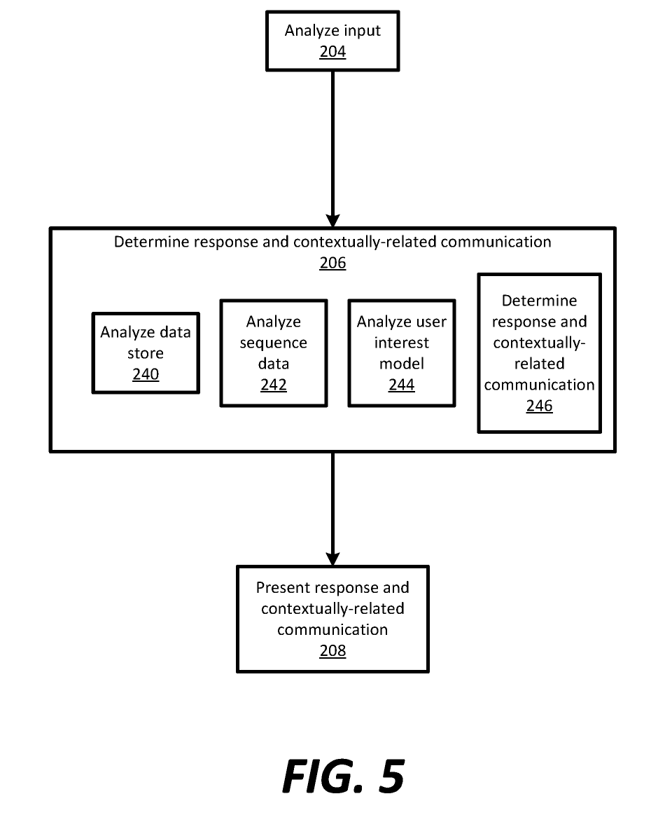

Referring now to FIG. 5, determining response and contextually-related communication (operation 206) includes analyzing the data store (operation 240), analyzing sequence data (operation 242), analyzing user interest model (operation 244), and determining a response and contextually-related communication (operation 246). Contextually-related communication, as used with respect to this operation, includes queries, information, requests, etc., related to a task that is determined based upon the input but is not explicitly requested or associated with received input. As such, the contextually-related communication relates to an additional task that was not specified by the received input but may be performed after in addition to providing a response explicitly identified by the received input. Contextually-related communication can be generated using static data or dynamic data. In examples, the contextually-related communication may be generated based upon a reactive model or proactive model. Further, contextually-related communication may be a system response based upon the additional context information, which may produce a more intelligent system response. As such, a contextually-related communication may comprise a prompt to execute a task and/or a prompt to request additional input required to execute the task. As previously discussed, the task identified by the contextually-related communication may be a task that was not explicitly requested by the received input but, nonetheless, may be related to the received input.

In many instances, there may be more than one possible response to the user's input. That is, there may be additional contextually-related communications that can be proactively triggered based upon the reactive response to the input originally received at operation 204. By identifying such contextually-related responses, the device performing the aspects disclosed herein may engage in a dialog with a user. The dialog may be used to perform additional tasks for the user without requiring the user to explicitly activate or otherwise invoke the task. The dialog may also be employed to teach a user about the different tasks that the device can perform on the user's behalf. The contextually-related communications may not be limited to the same domain or intent as the reactive response generated based upon the input originally received, for example, at operation 204. As such, the contextually-related communications may be determined by analyzing information, data flows, finite state diagrams, models, etc. from other knowledge bases. As previously described, the different types of data (e.g., different knowledge bases) may be provided in one or more data stores, such as data store 120 of FIG. 2. Analyzing the data store (operation 240) may include identifying one or more possible responses to the user's input, such as fetching the answer to the user's query. Analyzing the data store (operation 240) can also include identifying the most relevant response(s) for the particular user. User-specific information in the data store, such as search history, calendar, location, social media data, can be used to identify or rank the most relevant responses.

Sequence data are also analyzed (operation 242) during the determining response and contextually-related communication (operation 206). Analyzing sequence data (operation 242) includes analyzing any previous responses or queries from the user, as well as other users in similar contexts. Analyzing sequence data (operation 242) can also include determining relationships between various tasks, such as dependent, synergistic, related, contradictory, etc., so that additional dialog can be triggered given the user's current request and context.

A dependent task follows naturally from a previous user input. An example of a dependent task is: after the user input is to make a reservation at a restaurant, the user will need to travel to that location. The dependent task (how the user will get to the restaurant) can be based on data from earlier in the communication, the name and location of the restaurant and time of reservation, contextual data, such as the distance to the restaurant, the time of day, the weather, as well as other inferences made based on the user's historical patterns (usually walks, takes a cab, or drives).

A synergistic task is a task that is typically conducted alongside the current task. An example of a synergistic task is, continuing with the restaurant instance, to offer activities to the user based on their interests, such as a movie, stage plays, sporting events, or musical events.

A contradictory task is one that is in conflict with data already in the data store. For example, a user requests a dinner reservation at 6 pm, but the user has a meeting scheduled from 5 pm until 6:30 pm in a different location. Because the user cannot attend both, the user might be presented with additional contextually-related communication regarding rescheduling one or both of the meeting or dinner reservation.

Generally, sequence data include decision flows or finite state diagrams, for various domains that include a progression of decisions relevant to the input. As discussed above, some sequences may include multiple prompts for additional information. Analyzing which prompts have been provided and the input received in response to the prompt tracking progress through the decision tree occurs during operation 242.

The user interest model may also be analyzed (operation 244). Analyzing the user interest model (operation 244) may include compiling a current user interest model based on the current context. The user interest model can be generated using data supplied by the user, such as contacts, schedule, and addresses, as well as inferred and implied user interests and contexts. In examples, some, or all, of the user-specific information shown in FIG. 2 is used to generate the user interest model. The user interest model provides the ability to customize responses for particular users.

Using historical data as well as contextual data can additionally improve the quality of data presented to the user because a given context might imply the user values one response, of many possible responses, more than the others. For example, the user has multiple searches in the past for a particular sports team, indicating that the user is interested in that team. However, the user's email includes tickets to a game between two different teams on a specific date. If the user asks about information on the date of that game, the user can be presented first with information involving the two teams in the game, rather than the third team the user has previously expressed interest in. As such, the aggregation of information collected from different sources increases the likelihood that a correct response is provided to the user as well as providing additional helpful functionality. This improves the user experience by reducing the number of times a user has to submit a query before she receives the correct answer. The additional tasks or functionality may also reduce the number of operations the user must perform to reach a desired outcome. This, in turn, has the effect of reducing bandwidth requirements and extending the battery life of devices.

Based on the results from analyzing the data store (operation 240), analyzing the relevant sequence data (operation 242), and analyzing the user interest model (operation 244), a response to the user's input is determined as well as contextually-related communication to be presented to the user (operation 246).

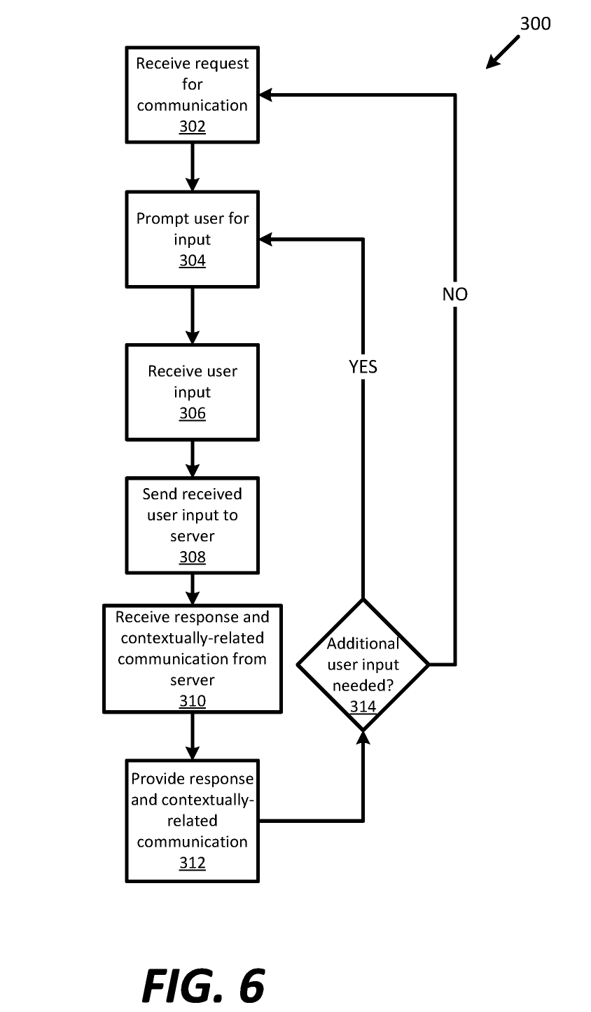

Referring again to FIG. 3, after determining the response and contextually-related communication (operation 206), the response is sent to the device (operation 208). As discussed with reference to FIG. 6 below, the response is presented to the user through text-to-speech and a speaker and/or presented to the user with on-screen text. Alternatively, the response may be graphically presented to the user.

In examples, the systems described herein may determine that the user can be presented with an option for receiving contextually-related communication (operation 209). If it is determined that the user should be presented with the option for receiving contextually-related communication, the text to display to the user is sent to the device (operation 209). For example, if the user queries for flights from San Francisco to Seattle, and the user is presented with a list of flight options, the user may then receive a notification such as “I can reserve a ticket for you. Would you like to book one of these flight options?” Then the user can select, verbally or using the touch interface on the device, one of the flight options.

In this way, the user is notified that the system has the capability to continue a logical progression based on the user's input, without the need for a dedicated notification on its own (that is, this is in contrast to notifying the user upon device start-up that the system has a capability, without prompting from the user).

In other instances, the contextually-related communication is sent to the device (operation 210) for presentation to the user without first informing the user about the system's capabilities. That is, example method 200 skips operation 209. For example, if a user has already been informed during a previous communication that the personal digital assistant can call a taxi, then, in subsequent communications, the user is simply prompted whether they would like to call a taxi.

After presenting the response (operation 208) and/or the option for contextually-related communication (operation 209), the user is presented the contextually-related communication identified during operation 206. Then a determination is made whether a user response is needed (operation 211) based upon the contextually-related communication presented at operation 209. If no user response is needed, then the system returns to monitor for future user input.

If a user response is needed, then a prompt or message requesting a response or query from the user is sent to the device (operation 212). After sending the response (operation 212), the server expects to receive additional input, which is analyzed (operation 204). The example method 200 repeats until one or more of: the user indicates they no longer need assistance, the user fails to respond in a given time period, or the sequence finishes. As previously mentioned, the previously provided input during the process may be stored and used to determine a correct response and/or additional actions upon receiving subsequent input.

In some instances, the contextually-related communication may be the first of many prompts, or includes information and a prompt, in which case an additional user response is needed. An example is when the user queries how long it will take to drive home, and the response is a given amount of time, such as 45 minutes, an assessment that traffic is heavy, and a query whether the user would like an alternate route home.

FIG. 6 illustrates a block flow diagram of an aspect of an example method 300 for receiving and presenting dynamic contextual responses. The example method 300 may include receiving a request for communication (operation 302), prompting a user for input (operation 304), receiving user input (operation 306), sending the received user input to the server (operation 308), receiving a response and contextually-related communication from the server (operation 310), providing the response and contextually-related communication (operation 312), and determining whether additional user input is needed (operation 314). The exemplary method 300 shown in FIG. 6 may be performed by the device 104, shown and described with reference to FIG. 1 above. Other aspects can include more or fewer operations.

The exemplary method 300 begins when the device receives a request for communication (operation 302). For example, the user activates a personal digital assistant application. In an example, the user selects a search button on the device, which activates the personal digital assistant. Alternatively, the device may monitor all input received from the user. In such examples, a determination may be made as to whether the input requires a response from the application or device performing the method 300.

Once activated, the user is then prompted for input (operation 304). This can include displaying a message such as “How can I help you?” as well as audibly presenting the message to the user, such as through a speaker supported by the device. Alternatively, if the device is monitoring all input from the user, operation 304 may not be performed.

Then the device receives the input (operation 306). As mentioned above, the input can be a query, a request for an action, and/or an instruction. The input is typically spoken, and thus received by the device's microphone, although in aspects the user can type the input or selects an icon displayed on the device's display. Alternatively, the input may be received via a graphical user interface or from another application or process.

After receiving the input (operation 306), the device then sends the input to the server (operation 308). Upon sending the input to the server, the example method 200 shown in FIG. 3 begins with receive input (operation 202).

After the server determines the response and contextually-related communication, the device receives the response and contextually-related communication from the server (operation 310). Then the device provides, in examples, by visually displaying or audibly presenting (e.g., speaking), the response and contextually-related communication (operation 312).

If additional input is needed (decision 314), then the device again prompts the user for input (operation 304) and then receives the input (operation 306). Otherwise, the device returns to the state when it is ready to receive a request for communication (operation 302).

Having described various aspects of systems and methods for providing dynamic reactive services, the disclosure will now describe various computing devices and operating environment that may be used to implement such systems and methods.

FIGS. 7-10 and the associated descriptions provide a discussion of a variety of operating environments in which aspects of the disclosure may be practiced. However, the devices and systems illustrated and discussed with respect to FIGS. 7-10 are for purposes of example and illustration and are not limiting of a vast number of computing device configurations that may be utilized for practicing aspects of the disclosure, described herein.

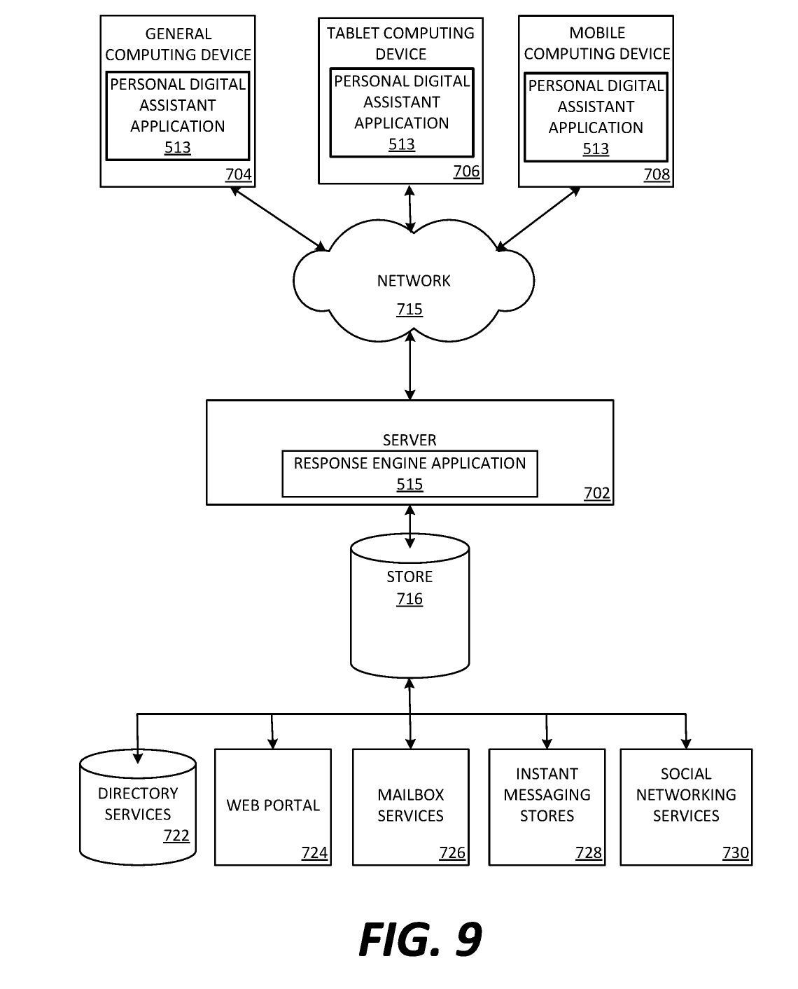

FIG. 7 is a block diagram illustrating physical components (e.g., hardware) of a computing device 500 with which aspects of the disclosure may be practiced. The computing device components described below may have computer executable instructions for recursively computing hash code for a plurality of expression tree nodes, determining whether hash code for each of the plurality of expression tree nodes is stored in a cached intern pool, and upon determining that at least one of the plurality of expression tree nodes is not stored in the cached intern pool, running at least one function on the at least one of the plurality of expression tree nodes for determining whether that at least one of the plurality of expression tree nodes should be stored in the cached intern pool, on a server computing device such as, for example, server 702 shown in FIG. 9, including computer executable instructions for response engine application 515 that can be executed to employ the methods disclosed herein. In a basic configuration, the computing device 500 may include at least one processing unit 502 and a system memory 504. Depending on the configuration and type of computing device, the system memory 504 may comprise, but is not limited to, volatile storage (e.g., random access memory), non-volatile storage (e.g., read-only memory), flash memory, or any combination of such memories. The system memory 504 may include an operating system 505 and one or more sets of instructions 506 suitable for executing a personal digital assistant application 513 and/or a response engine application 515. The operating system 505, for example, may be suitable for controlling the operation of the computing device 500. Furthermore, aspects of the disclosure may be practiced in conjunction with a graphics library, other operating systems, or any other application program and is not limited to any particular application or system. This basic configuration is illustrated in FIG. 7 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 7 by a removable storage device 509 and a non-removable storage device 510.

As stated above, a number of computer executable instructions and/or data files may be stored in the system memory 504. While executing on the processing unit 502, computer executable instructions (e.g., expression tree interning application 520) may perform processes including, but not limited to, the various aspects, as described herein. Other program modules (i.e., sets of computer executable instructions) may be used in accordance with aspects of the present disclosure, for example the exemplary personal digital assistant application 513 and/or a response engine application 515.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 500 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 500 may also have one or more input device(s) 512 such as a keyboard, a mouse, a pen, a sound or voice input device, a touch or swipe input device, etc. The output device(s) 514 such as a display, speakers, a printer, etc. may also be included. The aforementioned devices are examples and others may be used. The computing device 500 may include one or more communication connections 516 allowing communications with other computing devices 550. Examples of suitable communication connections 516 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

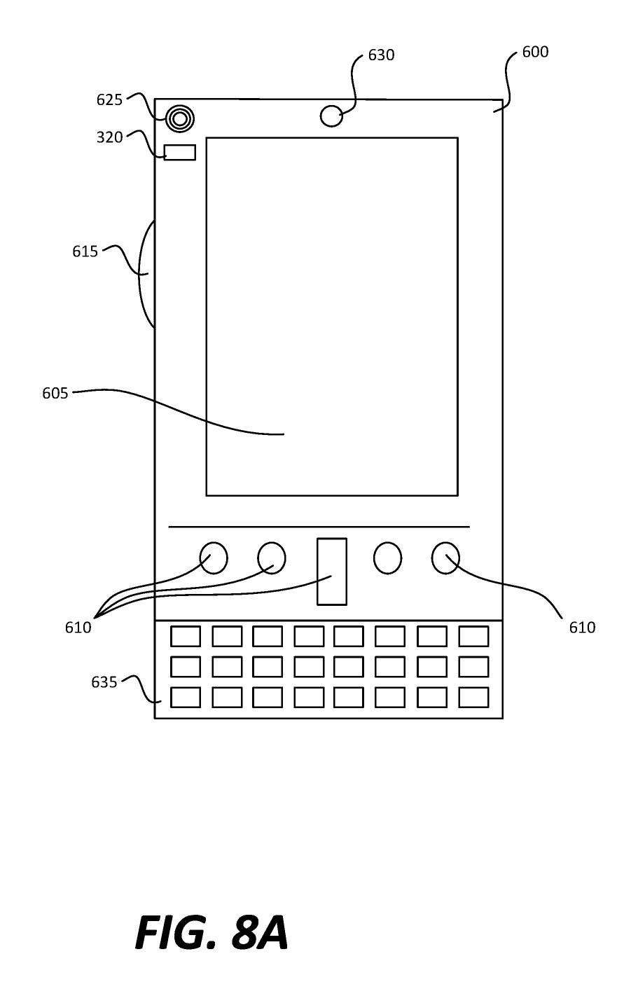

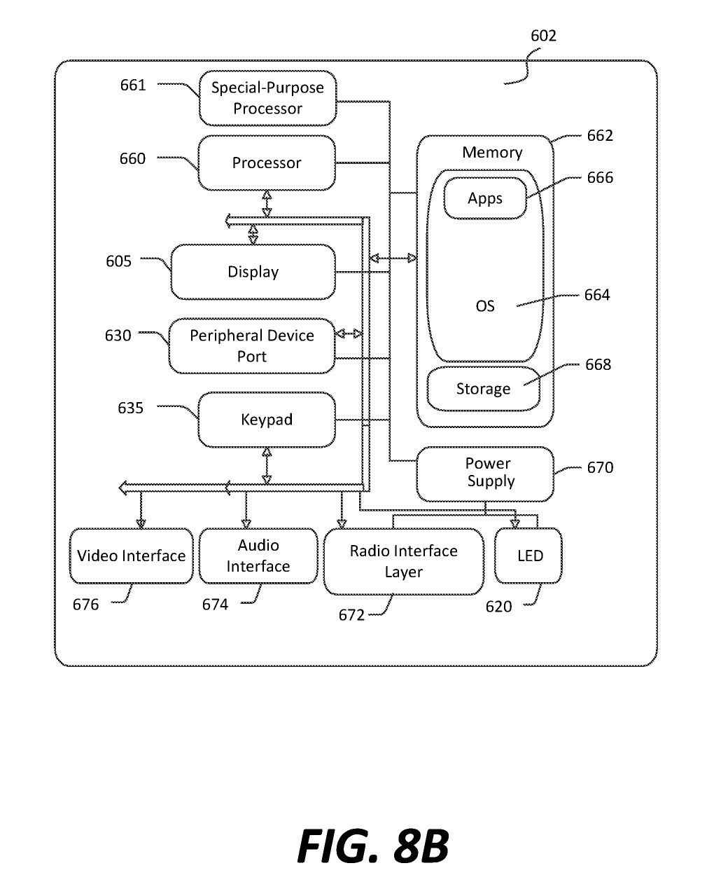

FIGS. 8A and 8B illustrate a mobile computing device 600, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 8A, one aspect of a mobile computing device 600 for implementing the aspects is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. The display 605 of the mobile computing device 600 may also function as an input device (e.g., a touch screen display). If included, an optional side input element 615 allows further user input. The side input element 615 may be a rotary switch, a button, or any other type of manual input element. In alternative aspects, mobile computing device 600 may incorporate more or less input elements. For example, the display 605 may not be a touch screen in some embodiments. In yet another alternative embodiment, the mobile computing device 600 is a portable phone system, such as a cellular phone. The mobile computing device 600 may also include an optional keypad 635. Optional keypad 635 may be a physical keypad or a “soft” keypad generated on the touch screen display. In various embodiments, the output elements include the display 605 for showing a graphical user interface (GUI), a visual indicator 620 (e.g., a light emitting diode), and/or an audio transducer 625 (e.g., a speaker). In some aspects, the mobile computing device 600 incorporates a vibration transducer for providing the user with tactile feedback. In yet another aspect, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 8B is a block diagram illustrating the architecture of one aspect of a mobile computing device. That is, the mobile computing device 600 can incorporate a system (e.g., an architecture) 602 to implement some aspects. In one embodiment, the system 602 is implemented as a “smart phone” capable of running one or more applications (e.g., browser, e-mail, calendaring, contact managers, messaging clients, games, an execution engine, and/or media clients/players). In some aspects, the system 602 is integrated as a computing device, such as an integrated personal digital assistant (PDA) and wireless phone.

One or more application programs 666 may be loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. The system 602 also includes a non-volatile storage area 668 within the memory 662. The non-volatile storage area 668 may be used to store persistent information that should not be lost if the system 602 is powered down. The application programs 666 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600, including the instructions for performing interning of expression trees as described herein (e.g., recursive hash code generator, hash code storage engine, node storage engine, shared node engine, etc.).

The system 602 has a power supply 670, which may be implemented as one or more batteries. The power supply 670 might further include an external power source, such as an AC adapter or a powered docking cradle that supplements or recharges the batteries.

The system 602 may also include a radio interface layer 672 that performs the function of transmitting and receiving radio frequency communications. The radio interface layer 672 facilitates wireless connectivity between the system 602 and the “outside world,” via a communications carrier or service provider. Transmissions to and from the radio interface layer 672 are conducted under control of the operating system 664. In other words, communications received by the radio interface layer 672 may be disseminated to the application programs 666 via the operating system 664, and vice versa.

The visual indicator 620 may be used to provide visual notifications, and/or an audio interface 674 may be used for producing audible notifications via the audio transducer 625. In the illustrated embodiment, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. In accordance with embodiments of the present disclosure, the microphone may also serve as an audio sensor to facilitate control of notifications, as will be described below. The system 602 may further include a video interface 676 that enables an operation of an on-board camera 630 to record still images, video stream, and the like.

A mobile computing device 600 implementing the system 602 may have additional features or functionality. For example, the mobile computing device 600 may also include additional data storage devices (removable and/or non-removable) such as, magnetic disks, optical disks, or tape. Such additional storage is illustrated in FIG. 8B by the non-volatile storage area 668.

Data/information generated or captured by the mobile computing device 600 and stored via the system 602 may be stored locally on the mobile computing device 600, as described above, or the data may be stored on any number of storage media that may be accessed by the device via the radio interface layer 672 or via a wired connection between the mobile computing device 600 and a separate computing device associated with the mobile computing device 600, for example, a server computer in a distributed computing network, such as the Internet. As should be appreciated such data/information may be accessed via the mobile computing device 600 via the radio interface layer 672 or via a distributed computing network. Similarly, such data/information may be readily transferred between computing devices for storage and use according to well-known data/information transfer and storage means, including electronic mail and collaborative data/information sharing systems.

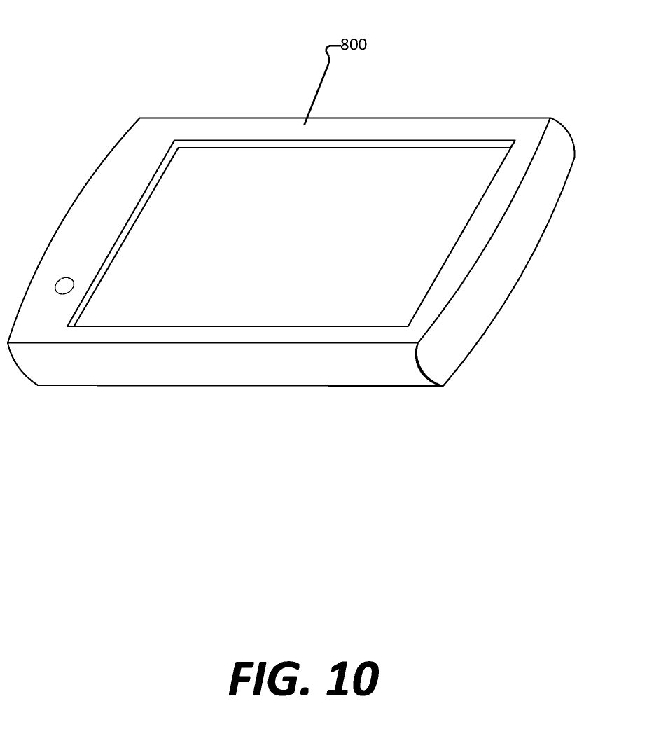

FIG. 9 illustrates one aspect of the architecture of a system for processing data received at a computing system from a remote source, such as a personal computer 704, tablet computing device 706, or mobile computing device 708, as described above. Content displayed at server device 702 may be stored in different communication channels or other storage types. For example, various documents may be stored using a directory service 722, a web portal 724, a mailbox service 726, an instant messaging store 728, or a social networking site 730. The instructions for the personal digital assistant application 513 may be employed by a client that communicates with server device 702, and/or the instructions for the response engine application 515 may be employed by server device 702. The server device 702 may provide data to and from a client computing device such as a personal computer 704, a tablet computing device 706 and/or a mobile computing device 708 (e.g., a smart phone) through a network 715. By way of example, the computer system described above with respect to FIGS. 9-10 may be embodied in a personal computer 704, a tablet computing device 706 and/or a mobile computing device 708 (e.g., a smart phone). Any of these embodiments of the computing devices may obtain content from the store 716, in addition to receiving graphical data useable to be either pre-processed at a graphic-originating system, or post-processed at a receiving computing system.

FIG. 10 illustrates an exemplary tablet computing device 800 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

### EXAMPLES

Below are two examples of interactions between a user (“U”) and the personal digital assistant (“PDA”). Generally, the user's input correspond to operation 306 in FIG. 6 and the PDA's responses correspond to operations 312 and/or 304 in FIG. 6. These examples are in no way limiting and are presented solely to illustrate the dynamic capability of the contemplated aspects.

### Example 1

U: “Find a nearby Italian restaurant.”
PDA: “Here is a list of four Italian restaurants. Would you like to make a reservation at one of them?”
U: “Make a reservation for four people at Pasta at 6:30 pm tonight.”
PDA: “You have a meeting on your calendar until 7 pm tonight. Do you want me to make the reservation for 7:15 pm instead?”
U: “Yes. Make the reservation for 7:15 pm.”
PDA: “It is going to rain tonight. Would you like me to arrange for a taxi?”
U: “Yes. Have the taxi pick me up at this location”
PDA: “It will take approximately 10 minutes to get to Pasta based on current traffic conditions. Should I reserve the taxi for 7:05 pm?”
U: “Please have the taxi pick me up at 7 pm.”
PDA: “Would you like to notify the other guests?”
U: “Please send a notification to Bob Jones, Sandy Gray, and Ellen Timber and include the reservation details and the taxi cab details.
PDA: “Okay. Is there anything else?”
U: “No.”

### Example 2

U: “Send a message to Bob Jones and Sandy Gray that I am running late.”
PDA: “Okay. I can move your calendar appointment for that meeting. Would you like me to do that?”
U: “Yes. Please move it back 15 minutes.”
PDA: “Okay. I moved the calendar appointment back 15 minutes. I can change the meeting location based on the availability of meeting rooms. Would you like me to do that?”
U: “Yes.”
PDA: “Okay. You are now meeting in the Keystone room. I also updated the calendar appointment notice. Would you like me to send the updated calendar notice to Bob and Sandy?”
U: “Yes.”

Among other examples, the present disclosure presents systems and methods, comprising at least one processor and memory encoding computer executable instructions that, when executed by at least one processor, cause the at least one processor to: receive an input; determine contextual information about the input; generating a response to the input based upon an input-specific domain; generating contextually-related communication based upon a related-task domain, wherein the contextually-related communication is based on the contextual information; and wherein the related-task domain comprises user-specific information; provide the response to the input; and provide the contextually-related communication. In further examples, the system and methods identify a domain related to the input; and the contextually-related communication is further based on the domain related to the input. In further examples, the input is spoken or typed and the input is a query. In further examples, the input-specific domain comprises user-specific information and wherein the input is an instruction. In further examples, the system and methods receive a response to the contextually-related communication from the user; generate a follow-up reply based on the response to the contextually-related communication; and provide the follow-up reply. In further examples, generating the follow-up reply is additionally based on the input-specific domain and the related-task domain; and the user-specific information comprises at least one of search data and services data. In further examples, the contextual information comprises at least one of a location of the user and a time of day. In further examples, the related-task domain comprises sequence data and wherein the user-specific information comprises social media data and a list of available applications. In further examples, the systems and methods provide a notification to the user of a capability of the system, wherein the notification is provided before providing the contextually-related communication and after providing the response to the input.

Further aspects disclosed herein provide exemplary systems and methods for providing a response and contextually-related communication to a user, comprising: receiving an input; determining contextual information about the input; identifying a domain related to the input; generating a response to the input based upon an input-specific domain; generating a contextually-related communication based upon a related-task domain, wherein the contextually-related communication is based on the contextual information and on the domain related to the input; and wherein the related-task domain comprises user-specific information; providing the response to the input; and providing the contextually-related communication. In further examples, the systems and methods further comprise receiving a response to the contextually-related communication from the user; generating a follow-up reply based on the response to the contextually-related communication; and providing the follow-up reply. In further examples, generating the follow-up reply is additionally based on the input-specific domain and the related-task domain; and the user-specific information comprises at least one of search data and services data. In further examples, the input is spoken or typed and wherein the input is a query. In further examples, the input-specific domain comprises user-specific information; the contextual information comprises at least one of a location of the user and a time of day; the related-task domain comprises sequence data; and the user-specific information comprises social media data and a list of available applications. In further examples, the systems and methods further comprise providing a notification to the user of a capability of the system, where the notification is provided before providing the contextually-related communication and after providing the response to the input; and where the response to the contextually-related communication is an instruction. In further examples, the systems and methods comprise activating an application accessible by the user device based on the response to the contextually-related communication; and completing an action with the application based on the response to the contextually-related communication.

Additional aspects disclosed herein provide systems and methods for presenting a response and contextually-related communication to an input from a user, comprising: receiving an input; determining contextual information about the input; identifying a domain related to the input; generating a response to the input based on an input-specific domain; generating a contextually-related communication based on a related-task domain, wherein the contextually-related communication is based on the contextual information and on the domain related to the input; and wherein the related-task domain comprises user-specific information; providing the response to the input; providing the contextually-related communication; receiving a response to the contextually-related communication from the user; generating a follow-up reply based on the response to the contextually-related communication; and providing the follow-up reply. In further examples, the input is spoken or typed and the input is a query; generating the follow-up reply is additionally based on the input-specific domain and the related-task domain; the user-specific information comprises search data and services data; the input-specific domain comprises user-specific information; the contextual information comprises a location of the user and a time of day; the related-task domain comprises sequence data; and the user-specific information comprises social media data and a list of available applications. In further examples, the methods and systems further comprise providing a notification to the user of a capability of the system, where the notification is provided before providing the contextually-related communication and after providing the response to the input. In further examples, the response to the contextually-related communication is an instruction; and the systems and methods further comprise activating an application accessible by the user device based on the response to the contextually-related communication and completing an action with the application based on the response to the contextually-related communication.

The aspects described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices can be employed to perform the functionality disclosed herein without departing from the scope of the disclosure.

This disclosure described some aspects of the present technology with reference to the accompanying drawings, in which only some of the possible aspects were described. Other aspects can, however, be embodied in many different forms and the specific aspects disclosed herein should not be construed as limited to the various aspects of the disclosure set forth herein. Rather, these exemplary aspects were provided so that this disclosure was thorough and complete and fully conveyed the scope of the other possible aspects to those skilled in the art. For example, aspects of the various aspects disclosed herein may be modified and/or combined without departing from the scope of this disclosure.

Although specific aspects were described herein, the scope of the technology is not limited to those specific aspects. One skilled in the art will recognize other aspects or improvements that are within the scope and spirit of the present technology. Therefore, the specific structure, acts, or media are disclosed only as illustrative aspects. The scope of the technology is defined by the following claims and any equivalents therein.

What is claimed is:

1. A system, comprising:
at least one processor; and
memory encoding computer executable instructions that, when executed by at least one processor, cause the at least one processor to:
receive an input;
determine contextual information about the input;
generating a response to the input based upon an input-specific domain;
generating a contextually-related communication based upon a related-task domain,
wherein the contextually-related communication is based on the contextual information; and
wherein the related-task domain comprises user-specific information;
provide the response to the input; and
provide the contextually-related communication.

2. The system of claim 1, wherein the memory encoding computer executable further comprises instructions that, when executed by at least one processor, cause the processor to:
identify a domain related to the input; and
wherein the contextually-related communication is further based on the domain related to the input.

3. The system of claim 2, wherein the input is spoken and wherein the input is a query.

4. The system of claim 2, wherein the input-specific domain comprises user-specific information and wherein the input is an instruction.

5. The system of claim 1, wherein the memory encoding computer executable further comprises instructions that, when executed by at least one processor, cause the processor to:
receive a response to the contextually-related communication;
generate a follow-up reply based on the response to the contextually-related communication; and
provide the follow-up reply.

6. The system of claim 5, wherein generating the follow-up reply is additionally based on at least one of the input-specific domain and the related-task domain; and
wherein the user-specific information comprises at least one of search data and services data.

7. The system of claim 6, wherein the contextual information comprises at least one of a location of the user and a time of day.

8. The system of claim 7, wherein the related-task domain comprises sequence data and wherein the user-specific information comprises social media data and a list of available applications.

9. The system of claim 1, wherein the memory encoding computer executable further comprises instructions that, when executed by at least one processor, cause the processor to:
provide a notification to the user of a capability of the system, wherein the notification is provided before providing the contextually-related communication and after providing the response to the input.

10. A method for providing a response and contextually-related communication to a user, comprising:
receiving an input;
determining contextual information about the input;
identifying a domain related to the input;
generating a response to the input based upon an input-specific domain;
generating a contextually-related communication based upon a related-task domain,
wherein the contextually-related communication are based on the contextual information and on the domain related to the input; and
wherein the related-task domain comprises user-specific information;
providing the response to the input; and
providing the contextually-related communication.

11. The method of claim 10, further comprising:
receiving a response to the contextually-related communication;
generating a follow-up reply based on the response to the contextually-related communication; and
providing the follow-up reply.

12. The method of claim 11, wherein generating the follow-up reply is additionally based on the input-specific domain and the related-task domain; and
wherein the user-specific information comprises at least one of search data and services data.

13. The method of claim 12, wherein the input is spoken and wherein the input is a query.

14. The method of claim 13, wherein the input-specific domain comprises user-specific information;
wherein the contextual information comprises at least one of a location of the user and a time of day;
wherein the related-task domain comprises sequence data; and
wherein the user-specific information comprises social media data and a list of available applications.

15. The method of claim 14, wherein the method further comprises providing a notification to the user of a capability of the system,
wherein the notification is provided before providing the contextually-related communication and after providing the response to the input; and
wherein the response to the contextually-related communication are an instruction.

16. The method of claim 15, further comprising:
activating an application accessible by the user device based on the response to the contextually-related communication; and
completing an action with the application based on the response to the contextually-related communication.

17. A method for presenting a response and contextually-related communication to an input from a user, comprising:
receiving an input;
determining contextual information about the input;
identifying a domain related to the input;
generating a response to the input based on an input-specific domain;
generating a contextually-related communication based on a related-task domain,
wherein the contextually-related communication are based on the contextual information and on the domain related to the input; and
wherein the related-task domain comprises user-specific information;
providing the response to the input;
providing the contextually-related communication;
receiving a response to the contextually-related communication from the user;
generating a follow-up reply based on the response to the contextually-related communication; and
providing the follow-up reply.

18. The method of claim 17, wherein the input is spoken and wherein the input is a query;
wherein generating the follow-up reply is additionally based on the input-specific domain and the related-task domain;
wherein the user-specific information comprises search data and services data;
wherein the input-specific domain comprises user-specific information;
wherein the contextual information comprises a location of the user and a time of day;
wherein the related-task domain comprises sequence data; and
wherein the user-specific information comprises social media data and a list of available applications.

19. The method of claim 18, wherein the method further comprises providing a notification to the user of a capability of the system,
wherein the notification is provided before providing the contextually-related communication and after providing the response to the input.

20. The method of claim 19, wherein the response to the contextually-related communication are an instruction; and further comprising:
activating an application accessible by the user device based on the response to the contextually-related communication; and
completing an action with the application based on the response to the contextually-related communication.
